(19) United States
(12) Patent Application Publication
(10) Pub. No.: US 2022/0284290 A1
(43) Pub. Date: Sep. 8, 2022

(54) DATA-DRIVEN WEIGHT INITIALIZATION FOR MACHINE LEARNING MODELS

(71) Applicant: QUALCOMM Incorporated, San Diego, CA (US)

(72) Inventors: Debasmit DAS, San Diego, CA (US); Yash Sanjay BHALGAT, San Diego, CA (US); Fatih Murat PORIKLI, San Diego, CA (US)

(21) Appl. No.: 17/653,855

(22) Filed: Mar. 7, 2022

Related U.S. Application Data
(60) Provisional application No. 63/157,453, filed on Mar. 5, 2021.

(51) Int. Cl. G06N 3/08

(52) U.S. Cl. CPC G06N 3/08

(57) ABSTRACT

Certain aspects of the present disclosure provide techniques for provide a method, comprising: receiving input data for a layer of a neural network model; selecting a target code for the input data; and determining weights for the layer based on an autoencoder loss and the target code.

### CROSS-REFERENCE TO RELATED APPLICATIONS

This Application claims the benefit of and priority to U.S. Provisional Patent Application No. 63/157,453, filed on Mar. 5, 2021, the entire contents of which are incorporated herein by reference.

### INTRODUCTION

Aspects of the present disclosure relate to weight initialization for machine learning models.

Machine learning is generally the process of producing a trained model (e.g., an artificial neural network), which represents a generalized fit to a set of training data. Applying the trained model to new data enables generation of inferences, which may be used to gain insights into the new data.

Though machine learning models are able to learn through various training techniques, giving them significant expressive power, a challenge remains in how to initialize such models prior to training. Importantly, the manner of initializing a machine learning model prior to training can affect the resulting model's performance after training. Conventional initialization techniques, such as random initializations, can lead to inferior model training and performance.

Accordingly, improved methods for initialization of machine learning models are needed.

### BRIEF SUMMARY

Certain aspects provide a method, comprising: receiving input data for a layer of a neural network model; selecting a target code for the input data; and determining weights for the layer based on an autoencoder loss and the target code.

Other aspects provide processing systems configured to perform the aforementioned methods as well as those described herein; non-transitory, computer-readable media comprising instructions that, when executed by one or more processors of a processing system, cause the processing system to perform the aforementioned methods as well as those described herein; a computer program product embodied on a computer readable storage medium comprising code for performing the aforementioned methods as well as those further described herein; and a processing system comprising means for performing the aforementioned methods as well as those further described herein.

The following description and the related drawings set forth in detail certain illustrative features of one or more embodiments.

### BRIEF DESCRIPTION OF THE DRAWINGS

The appended figures depict certain aspects of the one or more embodiments and are therefore not to be considered limiting of the scope of this disclosure.

FIG. 1 depicts an example neural network model architecture.

FIG. 2 depicts an example data-driven weight initialization process.

FIG. 3 depicts an example autoencoder architecture.

FIG. 4 depicts an example method for autoencoder-based weight initialization.

FIG. 5 depicts an example processing system.

To facilitate understanding, identical reference numerals have been used, where possible, to designate identical elements that are common to the drawings. It is contemplated that elements and features of one embodiment may be beneficially incorporated in other embodiments without further recitation.

### DETAILED DESCRIPTION

Aspects of the present disclosure provide apparatuses, methods, processing systems, and non-transitory computer-readable mediums for data-driven weight initialization for machine learning models.

Deep neural networks have produced state-of-the-art recognition performance in areas like computer vision, natural language processing, speech recognition, user verification, and others. The success of these deep neural network models is generally attributable to the quality and quantity of datasets, complex architectures and algorithms, and advanced computing resources. However, less consideration has been given to developing novel and effective initialization schemes for these deep and complex architectures. In fact, without properly initializing neural networks, training becomes unstable and can result in vanishing or exploding gradients, which hinders trained model performance.

Generally, a “vanishing gradient” refers to the tendency of gradients to become too small during backpropagation through deep neural networks to be effective during training. This is because, according to the chain rule, the derivatives of each layer of the deep neural network are multiplied down the network (from the final layer to the initial layer) to compute the derivatives of the initial layers. When hidden layers use certain activation functions, like the sigmoid function, small derivatives for each hidden layer are multiplied together. Thus, the gradient decreases exponentially as the gradient backpropagates down to the initial layers. A small gradient means that the weights and biases of the initial layers will not be updated effectively with each training session. Because these initial layers may be important to recognizing core features of the input data, it can lead to overall inaccuracy of the neural network model even after training.

An “exploding gradient” refers to a related, but converse problem. Specifically, exploding gradients are a problem in which large error gradients accumulate layer-by-layer and result in very large updates to neural network model weights and biases during training. When the magnitudes of the gradients accumulate, an unstable neural network model is likely to occur, which can cause poor performance.

Proper model initialization is thus critical to the performance of machine learning models, such as deep neural network models. Generally, the goal of an initialization scheme is to obtain a set of parameters that set the initial state of a model, such as a neural network, into a basin of a good local minima with respect to the optimization landscape of those parameters. Since the optimization landscape might contain a large number of local minima, finding the right one is inherently difficult. Therefore, conventional approaches have chosen random initialization with the hope that the initial state lands in one of the basins of a good local minima.

For example, conventional methods have initialized the weights of a neural network using a Gaussian distribution with mean 0 and standard deviation 0.01. However, such initialization cannot be used for deeper networks as it will cause the gradients or activations (collectively, signals) to explode or vanish in the extreme layers. Hence, proper scaling of the activations needs to be carried out before forwarding to the next layer.

To take care of exploding and vanishing signals, conventional methods have applied a scaling factor to the standard deviation of the Gaussian distribution from which the weights are sampled. This scaling factor generally depends on the number of connections in and out of a layer, also referred to as the “fan-in” and “fan-out” of the layer. When weights are sampled from a scaled distribution, the variance of the activations and gradients are preserved.

Another conventional method uses an orthonormal matrix initialization, which may perform better than sampling weights from a Gaussian distribution. This approach may be further extended with a normalization scheme that scales the weights by the inverse of the square root of the variance of the batch activations.

Notably, in both the aforementioned conventional methods, weight parameter initialization is not data-dependent. That is, these conventional methods do not rely on any characteristics of the input data for initialization. To overcome the shortcoming of conventional methods, aspects described herein initialize weights for machine learning models, such as neural networks, based on characteristics of the input data (e.g., training data), which produces better training results and, in turn, better performing models. This performance improvement is created at least in part because exploiting the training data improves the probability that the initial state of the network is in the basin of a desired local minima.

Moreover, aspects described herein do not rely on normalization, which eliminates the computationally costly step of computing gradients—unlike other conventional data-driven methods that use, for example, principal components or k-means clustering to initialize weights, and require computation of gradients.

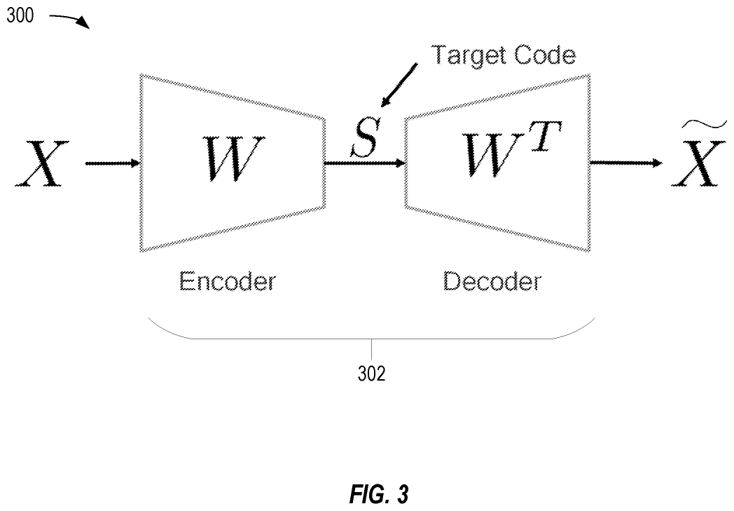

Specifically, aspects described herein utilize an efficient gradient-free approach to data-driven weight initialization. In some examples, a subset of the training data is used to feed input data to each layer of a neural network. This input data is then used to formulate an optimization problem wherein the weights are optimized to encode and decode the input data properly, such as by action of an autoencoder. Generally, an autoencoder is an unsupervised artificial neural network that learns how to efficiently compress and encode data and then learns how to reconstruct the data back from the reduced encoded representation (referred to as a latent encoding or latent code) to a representation that is as close to the original input as possible. Thus, autoencoders, by design, reduce data dimensions by learning how to ignore the noise in the data. An example of an autoencoder is described with respect to FIG. 3.

Beneficially, the data-driven weight initialization techniques described herein may be performed sequentially, layer after layer, in order to produce even more meaningful initialization in deeper layers of a machine learning model, such as a neural network. Unlike autoencoder based greedy pre-training, aspects described herein do not require training on the full dataset using gradient descent, which saves significant training time, compute resource, power, and memory.

For further efficiency, aspects described herein may ignore the nonlinear activations and provide flexibility to choose a latent code for the autoencoder, which allows the aforementioned optimization of the loss function without using gradient descent. The latent code generally refers to the encoded representation generated by the encoder portion of an autoencoder model. To this end, aspects described herein reformulate the optimal solution as the solution of a Sylvester equation, which has well-defined solvers, such as the Bartels-Steward algorithm. Generally, a Sylvester equation is a matrix equation of the form AX+XB=C, wherein given matrices A, B, and C, the problem is to find the possible matrix X that obeys the equation.

Aspects described herein are beneficial for many use cases. For example, the data-driven initialization methods described herein allow faster convergence during training, thus preserving energy and time for on-device training. This is particularly beneficial for battery-powered and low-powered devices, such as mobile devices, always-on devices, edge processing devices, Internet of Things (IoT) devices, and the like.

As another example, adapting neural networks to new users generally requires final layers to be trained from scratch. Such layers can use the data-driven initialization techniques described herein instead of random initialization to produce better trained, and more efficiently trained (e.g., compute cycles, power use, etc.) models as compared to conventional approaches.

As yet another example, in the case of few-training samples (e.g., few-shot learning), the data-driven initialization techniques described herein can produce better inductive biases than random initialization, thus leading to better training results and better model performance.

As a further example, neural architecture search conventionally requires computationally inefficient search of neural network spaces with random initialization. However, using the data-driven initialization methods described herein can beneficially reduce the number of possible search spaces and therefore speed up training and save resources.

### Example Weight Initialization of Neural Network

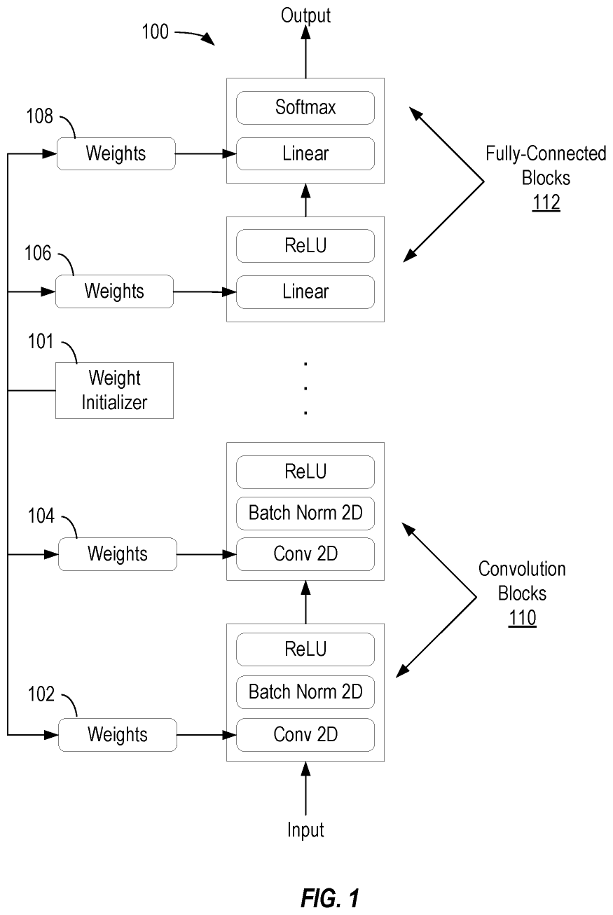

FIG. 1 depicts an example neural network model architecture 100 in which weights for various layers, including convolutional layers in convolution blocks 110 and fully-connected layers in fully-connected blocks 112, need initialization. In the depicted example, weight initializer 101 may be configured to initialize the weights (e.g., 102, 104, 106, and 108) for the various layers in accordance with the initialization methods described herein.

Conventionally, a weight initializer, such as 101, would initialize all weights 102, 104, 106, and 108 for their respective layers randomly and simultaneously. Aspects described herein, on the other hand, may initialize the layer weights sequentially using data-driven techniques that exploit characteristics of the training data to improve initialization.

For example, weights 102 may be initialized first, followed by weights 104, 106, and 108 in sequence—each layer benefiting from the data-driven initialization of the preceding layer. This allows for improved initialization of subsequent layers based on the optimized initialization of earlier layers.

Note that design of neural network architecture 100 is just one example, and any design or architecture could be initialized in other examples consistent with the aspects described herein.

### Example Data-Driven Weight Initialization Process

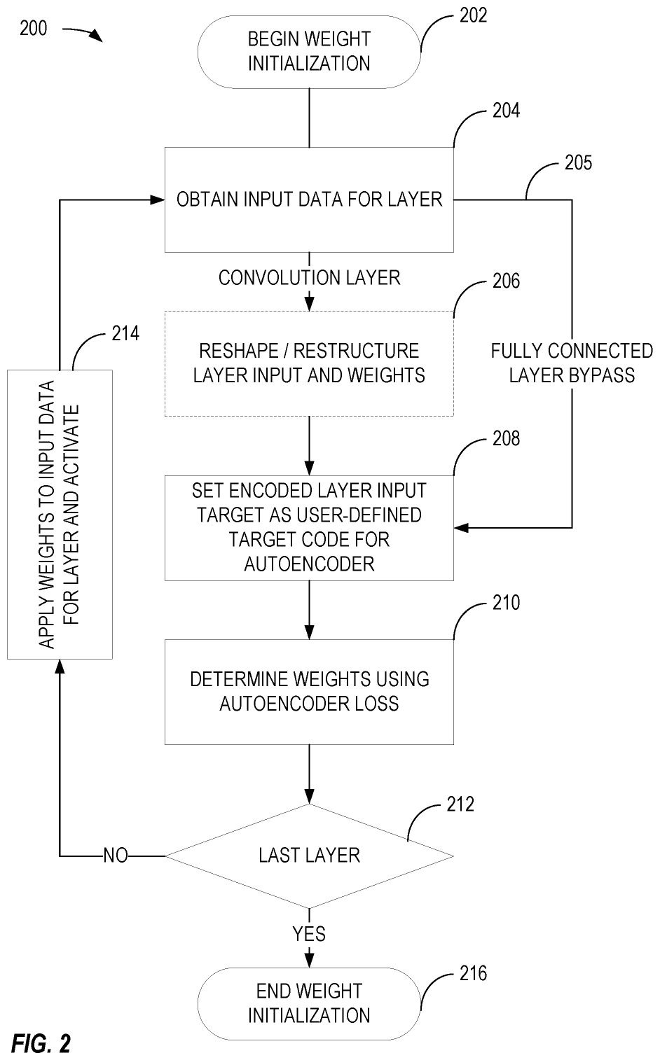

FIG. 2 depicts an example data-driven weight initialization process 200 for a machine learning model.

Process 200 begins at step 202 with initiating weight initialization. In some cases, weight initialization may be for an entire machine learning model (e.g., an entire neural network), or for some portion of it, such as a convolution block, a fully-connected block, a bottleneck block, or the final one or more fully connected layers (e.g., a classification stage) in a neural network where the feature extraction stage is pre-trained, to name just a few examples.

Initially, consider that process 200 has access to a labeled training dataset D={(xᵢ, yᵢ)}ᵢ₌₁^{N}, where N is the number of training samples. To improve efficiency, e.g., by reducing initialization and training time, a subset of the training data \tilde{D}⊂D may be used to initialize the network.

Process 200 then proceeds to step 204 with obtaining input data for a layer, such as any of the layers of the example neural network model architecture 100 in FIG. 1. Where the input data for the layer is from a previous layer, the input data may be in the form of activations produced by the preceding layer in the neural network model

Where the current layer being initialized is a fully-connected layer, step 206 may be skipped via bypass 205. Where the current layer being initialized is a convolution layer, the input data and weights may be reshaped at step 206 in order that a more efficient optimization procedure can be performed all at once (instead of iteratively based on patches of data corresponding to a strided convolution filter). Step 206 therefore reshapes the input data and weights (or a data structure for containing the weights) in order to effectively convert the convolution layer into a fully connected layer, which beneficially allows for exploiting various dimensionality reduction techniques efficiently.

For example, let the input to a convolutional layer be X∈ [symbol] ^{h×x×c}^{ᵢ}^{×n}, where h and w are the height and width of the input data map (also referred to as an activation map when the input data is from a preceding layer in the model), cᵢ is the number of input channels, and n is the number of samples used for the initialization. Let a convolution filter height, width and depth be fₕ, f_{w} and cᵢ, respectively. For an input data map from a single sample, a number of fₕ×f_{w}×cᵢ sized patches is obtained over which the filter convolves. This can be repeated over n samples. If nₚ be the total number of fₕ×f_{w}×cᵢ sized patches, then nₚ will depend both on n as well as stride and padding of the convolutional filter. These patches are then flattened to obtain a reshaped input activation X′∈ [symbol] ^{f}^{ₕ}^{f}^{_{w}}^{c}^{ᵢ}^{×n}^{ₚ}.

Similarly, let a convolutional weight be represented as a 4D tensor W∈ [symbol] ^{c}^{ₒ}^{×c}^{ᵢ}^{×f}^{ₕ}^{×f}^{_{w}}, where cₒ is the number of output channels. To enable compatibility with X′, W needs to be reshaped as W′ ∈ [symbol] ^{c}^{ₒ}^{×f}^{ₕ}^{f}^{_{w}}^{c}^{ᵢ}. Thus, the convolutional layer weights and input activations are restructured to that of a fully connected layer. For a fully-connected layer, the input activations and weights would be represented as X∈ [symbol] ^{d}^{ᵢ}^{×n} and W∈ [symbol] ^{d}^{ₒ}^{×d}^{ᵢ}, where dᵢ is the input dimension and dₒ is the output dimension. Equivalency of dimensions between convolutional and fully connected layers would be as follows: fₕf_{w}cᵢ≡dᵢ, nₚ≡n and cₒ≡dₒ.

Process 200 then proceeds to step 208 where an encoded layer input target is set as a user-defined target code (also referred to as a latent code) for an autoencoder. To produce a good initial weight W, the autoencoder should be able to encode the input activations X to an informative target code S∈ [symbol] ^{d}^{ₒ}^{×n}, which can then decode the original input activations. For simplicity and for weight-sharing, the decoder may be set to the transpose of the encoder, but other options are possible. Note that the choice of the target code S is flexible and possible options include, for example, principal components based on the input data, a Fisher discriminant (e.g., a method used to find a linear combination of features that characterizes or separates two or more classes of objects or events) based on the input data, a linear discriminant projection based on the input data, one-hot codes based on the input data, clusters based on the input data, hand-crafted features, and others.

Process 200 then proceeds to step 210 with determining the weights based on autoencoder losses, including in some examples an encoding loss component and a decoding loss component for the autoencoder. As described in more detail with respect to FIG. 3, the minimization of the autoencoding losses can be framed as a Sylvester equation (e.g., AX+XB=C), which may be efficiently solved using solvers, such as the Bartels-Steward algorithm. In some cases, the results of this procedure may lead to a local or global optimum for weights, which may be referred to as optimized weights.

Process 200 then proceeds to step 212 where a determination is made whether the layer being processed is the last layer needing processing.

If it is the last layer, then process 200 proceeds to step 216 where weight initialization is completed and, for example, training of the neural network may begin with the initialized weights.

If it is not the last layer, then process 200 proceeds to step 214 where the weights (e.g., as a result of step 210) are applied to the input data for the layer (e.g., as received at step 204) and an activation function is applied in order to produce activation data (e.g., an activation map) for a following or subsequent layer when the process returns to step 204.

Note that in this example, no activation is necessary for the optimization of weights at step 210, which beneficially reduces processing time and power for the optimization step. An activation may be applied in step 214 when feeding data forward to a subsequent layer of the model.

### Example Autoencoder-Based Optimization

FIG. 3 depicts an example autoencoder-based architecture 300. Note that architecture 300 may be used, for example, in connection with step 210 of FIG. 2.

As depicted, an autoencoder 302 takes an input X, encodes it into a target code (or latent code) S based on weights W and then decodes the target code via, in this example, the transpose of W, W^{T}, to recover a reconsustructed input \tilde{X}.

Various examples of target codes S were previously descirbed. To illustrate the technique, consider the example of a cluster-based latent code S.

For example, for input activations X∈ [symbol] ^{d}^{ᵢ}^{×n}, k-means clustering may be applied to obtain k=dₒ clusters arranged in a matrix H∈ [symbol] ^{d}^{ᵢ}^{×d}^{ₒ}. Then, an inner product may be applied between the input data and the cluster centers to obtain S=H^{T}X. The S is then used to obtain the layer weights W as described below.

In some aspects, to optimize for W, a combination of encoding and decoding losses may be minimized according to the convex optimization problem (a convex optimization problem is an optimization problem in which the objective function is a convex function and the feasible set is a convex set) of Equation 1:

$${min}_{W} \underbrace{{‖ X - {W}^{T} S ‖}_{F}^{2}}_{Decoding Loss} + λ \underbrace{{‖ WX - S ‖}_{F}^{2}}_{Encoding Loss} , \qquad ( 1 )$$

where the encoding and decoding losses are calculated in this example as the Frobenius norm (a matrix norm of a matrix defined as the square root of the sum of the absolute squares of its elements), and the scalar λ weighs the encoding loss. Note that because the problem is convex, no initial weights W are necessary to solve Equation 1.

Increasing λ may generally increases model peformance (e.g., accuracy) to an extent. For example, testing has shown increasing λ>1 produces saturation in performance.

To obtain the optimal W, the derivative of Equation 1 is taken with respect to W, set to 0, and then re-arranged to obtain the following equation:

$$\underbrace{{SS}^{T}}_{A} W + W \underbrace{λ {XX}^{T}}_{B} = \underbrace{( 1 + λ ) S {X}^{T}}_{C} . \qquad ( 2 )$$

Equation 2 can then be formulated as a Sylvester equation by setting A=SS^{T}, B=λXX^{T} and C=(1+λ)SX^{T}. The Sylvester equation can be efficiently solved by various methods, including in one example the Bartels-Stewart algorithm, which has a worst-case time complexity of [symbol] (dᵢ³) with the assumption that dᵢ>dₒ. Notably, this suggests that the time complexity of the Sylvester solver is independent of the number of training samples n. However, time-complexity of obtaining the user-defined target code S can depend on n. Note that solving Equation 2 does not require processing pre-activations with an activation function of the layer, which saves additional procesing.

Once the optimal solution for W* is obtained (e.g., the ouptut of step 210 of FIG. 2), it is reshaped into the appropriate dimension if it represents a convolutional layer or else is kept intact if, for example, it is to be applied to a fully-connected layer. Then, the input data (e.g., input data map or input activation map) are processed with the initialized weights W* to obtain pre-activation data. The pre-activation data is then passed through the layer's activation function to generate activation data, which is used as input for the next layer. The process is then repeated for the next layer until the final layer initialization is complete.

### Example Method for Autoencoder-Based Weight Initialization

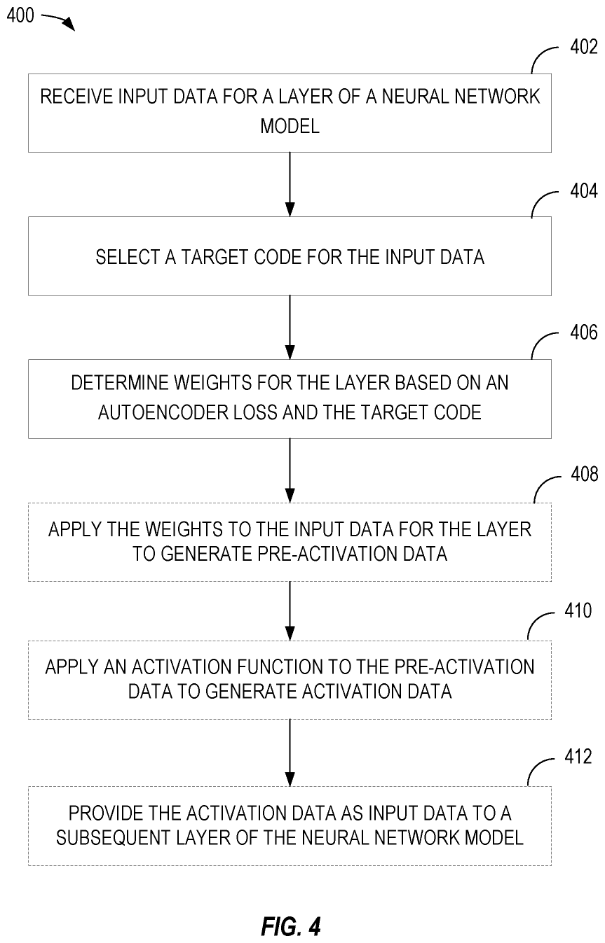

FIG. 4 depicts an example method 400 for autoencoder-based weight initialization.

Method 400 begins at step 402 with receiving input data for a layer of a neural network model. In some cases, the layer of the neural network model is one of a fully-connected layer or a convolution layer, as described above with respect to FIG. 1. However, other layer types may be used.

Method 400 then proceeds to step 404 with selecting a target code for the input data.

In some aspects, the target code is based on one of: one or more principal components of the input data for the layer; a linear discriminant projection of the input data for the layer; a Fischer discriminant based on the input data for the layer; a scaled one-hot code based on the input data for the layer; clustering of the input data for the layer, or one or more handcrafted features based on the input data for the layer. Note that these are just some examples, and others are possible.

Method 400 then proceeds to step 406 with determining weights for the layer based on an autoencoder loss and the target code. In some aspects, the autoencoder loss is calculated according to Equation 1, above.

In some aspects, determining weights for the layer based on an autoencoder loss comprises optimizing (e.g., minimizing) a combination of an encoding loss and a decoding loss, such as described with respect to FIG. 3. For example, determining weights for the layer based on an autoencoder loss may include determining a Sylvester equation based on the encoding loss and the decoding loss, and solving the Sylvester equation with a Bartels-Stewart algorithm.

In some aspects, the autoencoder comprises a first set of weights for an encoding component and a second set of weights for a decoding component. In some cases, the first set of weights is shared with the second set of weights. For example, as described above, the second set of weights may be a transpose of the first set of weights.

Where the layer is not the last layer in the neural network model, then the method proceeds to optional steps 408-412 to generate input data for the next layer in the model, which may be the activation data of the current layer based on the optimized weights.

For example, method 400 may then optionally proceeds to step 408 with applying the optimized weights to the input data for the layer to generate pre-activation data.

Method 400 then optionally proceeds to step 410 with applying an activation function to the pre-activation data to generate activation data. For example, the activation function may be a nonlinear activation function (e.g., ReLU, Swish, or the like).

Method 400 then optionally proceeds to step 412 with providing the activation data as input data to a subsequent layer of the neural network model.

Though not depicted in FIG. 4, in some cases, method 400 further includes providing the pre-activation data as input data to a subsequent layer of the neural network model, such as depicted and described with respect to FIG. 2.

Though not depicted in FIG. 4, in some cases, method 400 further includes selecting a subset of training data from a training dataset; and selecting the input data for the layer of the neural network model from the subset of training data. As above, selecting a subset of weight may improve training efficiency.

Though not depicted in FIG. 4, in some cases, method 400 further includes determining that the layer of the neural network model comprises a convolution layer; and reshaping the input data for the layer prior to determining the optimized weights for the layer. Method 400 may further include creating a weight data structure based on the reshaped input data for the layer.

Note that FIG. 4 is just one example of a method, and other methods including fewer, additional, or alternative steps are possible consistent with this disclosure.

### Example Processing System

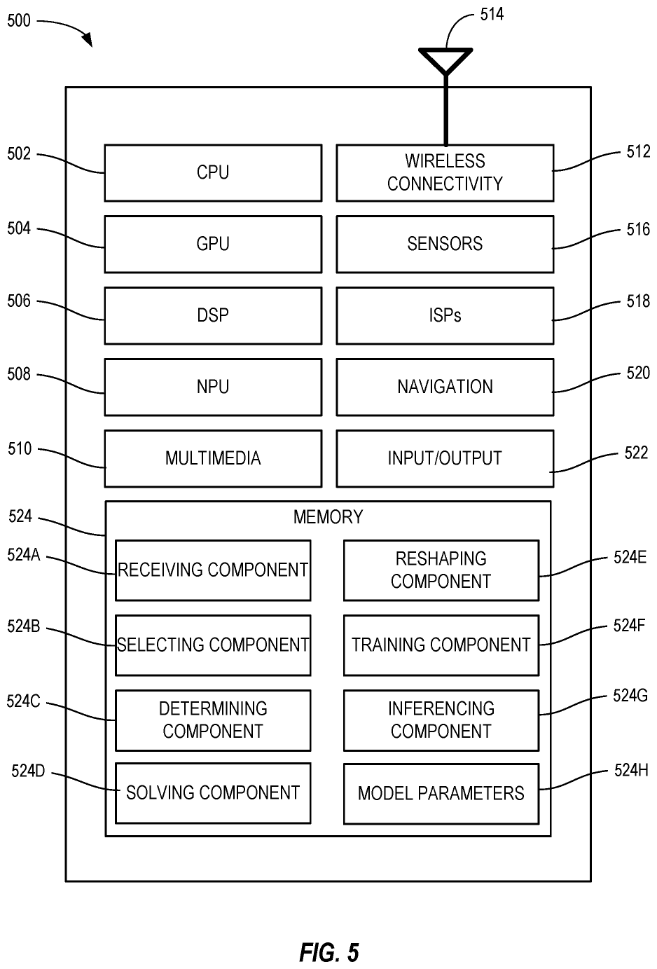

FIG. 5 depicts an example processing system 500 that may be configured to perform the methods described herein, such as with respect to FIGS. 2-4.

Processing system 500 includes a central processing unit (CPU) 502, which in some examples may be a multi-core CPU. Instructions executed at the CPU 502 may be loaded, for example, from a program memory associated with the CPU 502 or may be loaded from memory partition 524.

Processing system 500 also includes additional processing components tailored to specific functions, such as a graphics processing unit (GPU) 504, a digital signal processor (DSP) 506, a neural processing unit (NPU) 508, a multimedia processing unit 510, and a wireless connectivity component 512.

In some aspects, one or more of CPU 502, GPU 504, DSP 506, and NPU 508 may be configured to perform the methods described herein with respect to FIGS. 2-4.

An NPU, such as 508, is generally a specialized circuit configured for implementing all the necessary control and arithmetic logic for executing machine learning algorithms, such as algorithms for processing artificial neural networks (ANNs), deep neural networks (DNNs), random forests (RFs), kernel methods, and the like. An NPU may sometimes alternatively be referred to as a neural signal processor (NSP), a tensor processing unit (TPU), a neural network processor (NNP), an intelligence processing unit (IPU), or a vision processing unit (VPU).

NPUs, such as 508, may be configured to accelerate the performance of common machine learning tasks, such as image classification, machine translation, object detection, and various other tasks. In some examples, a plurality of NPUs may be instantiated on a single chip, such as a system on a chip (SoC), while in other examples they may be part of a dedicated machine learning accelerator device.

NPUs may be optimized for training or inference, or in some cases configured to balance performance between both. For NPUs that are capable of performing both training and inference, the two tasks may still generally be performed independently.

NPUs designed to accelerate training are generally configured to accelerate the optimization of new models, which is a highly compute-intensive operation that involves inputting an existing dataset (often labeled or tagged), iterating over the dataset, and then adjusting model parameters, such as weights and biases, in order to improve model performance. Generally, optimizing based on a wrong prediction involves propagating back through the layers of the model and determining gradients to reduce the prediction error.

NPUs designed to accelerate inference are generally configured to operate on complete models. Such NPUs may thus be configured to input a new piece of data and rapidly process it through an already trained model to generate a model output (e.g., an inference).

In some embodiments, NPU 508 may be implemented as a part of one or more of CPU 502, GPU 504, and/or DSP 506.

In some embodiments, wireless connectivity component 512 may include subcomponents, for example, for third generation (3G) connectivity, fourth generation (4G) connectivity (e.g., 4G LTE), fifth generation connectivity (e.g., 5G or NR), Wi-Fi connectivity, Bluetooth connectivity, and other wireless data transmission standards. Wireless connectivity processing component 512 is further connected to one or more antennas 514.

Processing system 500 may also include one or more sensor processing units 516 associated with any manner of sensor, one or more image signal processors (ISPs) 518 associated with any manner of image sensor, and/or a navigation processor 520, which may include satellite-based positioning system components (e.g., GPS or GLONASS) as well as inertial positioning system components.

Processing system 500 may also include one or more input and/or output devices 522, such as screens, touch-sensitive surfaces (including touch-sensitive displays), physical buttons, speakers, microphones, and the like.

In some examples, one or more of the processors of processing system 500 may be based on an ARM or RISC-V instruction set.

Processing system 500 also includes memory 524, which is representative of one or more static and/or dynamic memories, such as a dynamic random access memory, a flash-based static memory, and the like. In this example, memory 524 includes computer-executable components, which may be executed by one or more of the aforementioned components of processing system 500.

In particular, in this example, memory 524 includes receiving component 524A, selecting component 524B, determining component 524C, solving component 524D, reshaping component 524E, training component 524F, inferencing component 524G, and model parameters 524H (e.g., weights, biases, and other machine learning model parameters). One or more of the depicted components, as well as others not depicted, may be configured to perform various aspects of the methods described herein.

Generally, processing system 500 and/or components thereof may be configured to perform the methods described herein.

Notably, in other embodiments, aspects of processing system 500 may be omitted, such as where processing system 500 is a server computer or the like. For example, multimedia component 510, wireless connectivity 512, sensors 516, ISPs 518, and/or navigation component 520 may be omitted in other embodiments. Further, aspects of processing system 500 maybe distributed.

Note that FIG. 5 is just one example, and in other examples, alternative processing system with fewer, additional, and/or alternative components may be used.

### Example Clauses

Implementation examples are described in the following numbered clauses:

Clause 1: A method, comprising: receiving input data for a layer of a neural network model; selecting a target code for the input data; and determining weights for the layer based on an autoencoder loss and the target code.

Clause 2: The method of Clause 1, further comprising: applying the optimized weights to the input data for the layer to generate pre-activation data; applying an activation function to the pre-activation data to generate activation data; and providing the activation data as input data to a subsequent layer of the neural network model

Clause 3: The method of Clause 1, wherein determining weights for the layer based on an autoencoder loss comprises minimizing a combination of an encoding loss and a decoding loss.

Clause 4: The method of Clause 3, wherein determining weights for the layer based on an autoencoder loss comprises determining a Sylvester equation based on the encoding loss and the decoding loss.

Clause 5: The method of Clause 4, wherein determining weights for the layer based on an autoencoder loss comprises solving the Sylvester equation with a Bartels-Stewart algorithm.

Clause 6: The method of any one of Clauses 1-5, wherein an autoencoder used to generate the autoencoder loss comprises a first set of weights for an encoding component and a second set of weights for a decoding component.

Clause 7: The method of Clause 6, wherein the first set of weights is shared with the second set of weights.

Clause 8: The method of Clause 7, wherein the second set of weights is a transpose of the first set of weights.

Clause 9: The method of any one of Clauses 1-8, further comprising: selecting a subset of training data from a training dataset; and selecting the input data for the layer of the neural network model from the subset of training data.

Clause 10: The method of any one of Clauses 1-9, wherein the target code is based on one of: one or more principal components of the input data for the layer; a linear discriminant projection of the input data for the layer; a Fischer discriminant based on the input data for the layer; a scaled one-hot code based on the input data for the layer; clustering of the input data for the layer; or one or more handcrafted features based on the input data for the layer.

Clause 11: The method of any one of Clauses 1-10, further comprising: determining that the layer of the neural network model comprises a convolution layer; and reshaping the input data for the layer prior to determining the optimized weights for the layer.

Clause 12: The method of Clause 11, further comprising creating a weight data structure based on the reshaped input data for the layer.

Clause 13: The method of any one of Clauses 1-10, wherein the layer of the neural network model comprises a fully-connected layer.

Clause 14: A method, comprising: performing the method of any one of Clauses 1-13 iteratively for each layer of a plurality of layers of a machine learning model.

Clause 15: A method, comprising: inferencing with a machine learning model, wherein one or more of the machine learning model parameters were initialized according to the method of any one of Clauses 1-13.

Clause 16: A processing system, comprising: a memory comprising computer-executable instructions; one or more processors configured to execute the computer-executable instructions and cause the processing system to perform a method in accordance with any one of Clauses 1-15.

Clause 17: A processing system, comprising means for performing a method in accordance with any one of Clauses 1-15.

Clause 18: A non-transitory computer-readable medium comprising computer-executable instructions that, when executed by one or more processors of a processing system, cause the processing system to perform a method in accordance with any one of Clauses 1-15.

Clause 19: A computer program product embodied on a computer-readable storage medium comprising code for performing a method in accordance with any one of Clauses 1-15.

### Additional Considerations

The preceding description is provided to enable any person skilled in the art to practice the various embodiments described herein. The examples discussed herein are not limiting of the scope, applicability, or embodiments set forth in the claims. Various modifications to these embodiments will be readily apparent to those skilled in the art, and the generic principles defined herein may be applied to other embodiments. For example, changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

As used herein, the word “exemplary” means “serving as an example, instance, or illustration.” Any aspect described herein as “exemplary” is not necessarily to be construed as preferred or advantageous over other aspects.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

The methods disclosed herein comprise one or more steps or actions for achieving the methods. The method steps and/or actions may be interchanged with one another without departing from the scope of the claims. In other words, unless a specific order of steps or actions is specified, the order and/or use of specific steps and/or actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in figures, those operations may have corresponding counterpart means-plus-function components with similar numbering.

The following claims are not intended to be limited to the embodiments shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112(f) unless the element is expressly recited using the phrase “means for” or, in the case of a method claim, the element is recited using the phrase “step for.” All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

What is claimed is:

1. A processor-implemented method, comprising:
receiving input data for a layer of a neural network model;
selecting a target code for the input data; and
determining weights for the layer based on an autoencoder loss and the target code.

2. The method of claim 1, further comprising:
applying the weights to the input data for the layer to generate pre-activation data;
applying an activation function to the pre-activation data to generate activation data; and
providing the activation data as input data to a subsequent layer of the neural network model.

3. The method of claim 1, wherein determining weights for the layer based on an autoencoder loss comprises minimizing a combination of an encoding loss and a decoding loss.

4. The method of claim 3, wherein determining weights for the layer based on an autoencoder loss comprises determining a Sylvester equation based on the encoding loss and the decoding loss.

5. The method of claim 4, wherein determining weights for the layer based on an autoencoder loss comprises solving the Sylvester equation with a Bartels-Stewart algorithm.

6. The method of claim 1, wherein an autoencoder used to generate the autoencoder loss comprises a first set of weights for an encoding component and a second set of weights for a decoding component.

7. The method of claim 6, wherein the first set of weights is shared with the second set of weights.

8. The method of claim 7, wherein the second set of weights is a transpose of the first set of weights.

9. The method of claim 1, further comprising:
selecting a subset of training data from a training dataset; and
selecting the input data for the layer of the neural network model from the subset of training data.

10. The method of claim 1, wherein the target code is based on one of:
one or more principal components of the input data for the layer;
a linear discriminant projection of the input data for the layer;
a Fischer discriminant based on the input data for the layer;
a scaled one-hot code based on the input data for the layer;
clustering of the input data for the layer; or
one or more handcrafted features based on the input data for the layer.

11. The method of claim 1, further comprising:
determining that the layer of the neural network model comprises a convolution layer; and
reshaping the input data for the layer prior to determining the weights for the layer.

12. The method of claim 11, further comprising creating a weight data structure based on the reshaped input data for the layer.

13. The method of claim 1, wherein the layer of the neural network model comprises a fully-connected layer.

14. A method, comprising: performing the method of claim 1 iteratively for each layer of a plurality of layers of a machine learning model.

15. A processing system, comprising: a memory comprising computer-executable instructions; a processor configured to execute the computer-executable instructions and cause the processing system to:
receive input data for a layer of a neural network model;
select a target code for the input data; and
determine weights for the layer based on an autoencoder loss and the target code.

16. The processing system of claim 15, wherein the processor is further configured to cause the processing system to:
apply the weights to the input data for the layer to generate pre-activation data;
apply an activation function to the pre-activation data to generate activation data; and
provide the activation data as input data to a subsequent layer of the neural network model.

17. The processing system of claim 15, wherein in order to determine the weights for the layer based on an autoencoder loss, the processor is further configured to cause the processing system to minimize a combination of an encoding loss and a decoding loss.

18. The processing system of claim 17, wherein in order to determine weights for the layer based on an autoencoder loss, the processor is further configured to cause the processing system to determine a Sylvester equation based on the encoding loss and the decoding loss.

19. The processing system of claim 18, wherein in order to determine weights for the layer based on an autoencoder loss, the processor is further configured to cause the processing system to solve the Sylvester equation with a Bartels-Stewart algorithm.

20. The processing system of claim 15, wherein an autoencoder used to generate the autoencoder loss comprises a first set of weights for an encoding component and a second set of weights for a decoding component.

21. The processing system of claim 20, wherein the first set of weights is shared with the second set of weights.

22. The processing system of claim 21, wherein the second set of weights is a transpose of the first set of weights.

23. The processing system of claim 15, wherein the processor is further configured to cause the processing system to
select a subset of training data from a training dataset; and
select the input data for the layer of the neural network model from the subset of training data.

24. The processing system of claim 15, wherein the target code is based on one of:
one or more principal components of the input data for the layer;
a linear discriminant projection of the input data for the layer;
a Fischer discriminant based on the input data for the layer;
a scaled one-hot code based on the input data for the layer;
clustering of the input data for the layer; or
one or more handcrafted features based on the input data for the layer.

25. The processing system of claim 15, wherein the processor is further configured to cause the processing system to:
determine that the layer of the neural network model comprises a convolution layer; and
reshape the input data for the layer prior to determining the weights for the layer.

26. The processing system of claim 25, wherein the processor is further configured to cause the processing system to create a weight data structure based on the reshaped input data for the layer.

27. The processing system of claim 15, wherein the layer of the neural network model comprises a fully-connected layer.

28. A non-transitory computer-readable medium comprising computer-executable instructions that, when executed by one or more processors of a processing system, cause the processing system to perform a method, the method comprising:
receiving input data for a layer of a neural network model;
selecting a target code for the input data; and
determining weights for the layer based on an autoencoder loss and the target code.

29. The non-transitory computer-readable medium of claim 28, wherein the method further comprises:
applying the weights to the input data for the layer to generate pre-activation data;
applying an activation function to the pre-activation data to generate activation data; and
providing the activation data as input data to a subsequent layer of the neural network model.

30. The non-transitory computer-readable medium of claim 28, wherein determining weights for the layer based on an autoencoder loss comprises minimizing a combination of an encoding loss and a decoding loss.
